(19) United States
(12) Patent Application Publication
(10) Pub. No.: US 2023/0233970 A1
(43) Pub. Date: Jul. 27, 2023

(54) ACTIVATED CARBON-COMPOSITE MATERIALS, FILTERS, AND PREPARATION METHODS THEREOF

(71) Applicant: Qatar Foundation for Education, Science and Community Development, Doha (QA)

(72) Inventors: Rashad Al-Gaashani, Doha (QA); Muataz A. Hussien, Doha (QA); Viktor Kochkodan, Doha (QA)

(21) Appl. No.: 18/011,023

(22) PCT Filed: Jun. 15, 2021
(86) PCT No.: PCT/QA2021/050015

§ 371 Date: Dec. 16, 2022

Related U.S. Application Data
(60) Provisional application No. 63/040,289, filed on Jun. 17, 2020.

(51) Int. Cl. B01D 39/20

(52) U.S. Cl. CPC B01D 39/2062; B01D 39/2068; B01D 2239/065; B01D 2239/10

(57) ABSTRACT

A composite filtration material is provided as well as a method for preparing the same. A filter is also provided that is fabricated with the presently disclosed composite filtration material. In various aspects, the provided composite filtration material may include activated carbon doped with silver and/or iron oxide. A one-step thermal decomposition process is provided that may be employed to prepare the provided composite filtration materials. The one-step thermal decomposition process may include dissolving one or more precursors in water, spraying the dissolved one or more precursors onto activated carbon, and heating the activated carbon saturated with the one or more precursors for a predetermined amount of time. The inventors have found that the provided composite filtration materials are more effective (e.g., higher removal of pollutants) and have a longer service life as compared to typical activated carbon filtration materials.

### PRIORITY CLAIM

The present application claims priority to and the benefit of U.S. Provisional Application 63/040,289, filed Jun. 17, 2020, the entirety of which is herein incorporated by reference.

### TECHNICAL FIELD

The present application relates generally to filtration. More specifically, the present application provides a composite filtration material including activated carbon and a method of preparing the same via thermal decomposition.

### BACKGROUND

Drinking water can be exposed to bacterial growth during the flow of drinking water through a pipe network or during storage in reservoirs for a long time, especially at high outside temperatures. Drinking water turbidity can additionally increase while water taste and odor can decline. There is also a growing concern toward potential health risks posed by disinfection by-products (DBPs) in chlorinated drinking water. Drinking water must therefore typically be treated prior to being consumed.

Adsorption is a widely used typical method for water treatment. Activated carbon is one of the best adsorbents typically used. There are, however, several drawbacks with activated carbon as an absorbent, which are related to low sorption capacity and low removal of bacteria and heavy metals. These drawbacks of activated carbons are even more pronounced when used in environments with high outdoor temperatures.

Numerous attempts have been made to develop carbon-based sorbents and filters. One such sorbent is activated carbon doped/impregnated with silver adsorbents, which can be used for bacteria removal from water. Another such sorbent is activated carbon/iron oxide composite materials for removal of oil spills, heavy metals, phosphate and arsenic from water. These previous carbon-based sorbents, however, have typically involved the use of costly or toxic materials or very complex and time-consuming synthesis methods, which are difficult to scale up to commercial production level in order to have utility for large-scale water treatment for public use.

### SUMMARY

The present application provides new and innovative composite filtration materials including activated carbon that may be prepared with a one-step thermal decomposition process. In some aspects, a composite filtration material may include activated carbon doped with silver. In some aspects, a composite filtration material may include activated carbon doped with iron oxide. In some aspects, a composite filtration material may include activated carbon doped with silver and iron oxide. The one-step thermal decomposition process to prepare the provided composite filtration materials can take less time than at least some typical filtration material preparation methods. The inventors have also found that the provided composite filtration materials are more effective (e.g., higher removal of pollutants) and have a longer service life as compared to typical activated carbon filtration materials.

In light of the technical features set forth herein, and without limitation, in a first aspect of the disclosure in the present application, which may be combined with any other aspect unless specified otherwise, a method of preparing a composite filtration material includes dissolving one or more precursors in a liquid, thereby forming a mixture solution. The mixture solution may be sprayed on activated carbon such that the activated carbon is saturated with the mixture solution. The saturated activated carbon may then be heated for a predetermined amount of time, thereby forming the composite water filtration material.

In a second aspect of the disclosure in the present application, which may be combined with any other aspect (e.g., the first aspect) unless specified otherwise, the one or more precursors include iron (III) nitrate 9-hydrate (Fe(NO₃)₃·9H₂O).

In a third aspect of the disclosure in the present application, which may be combined with any other aspect (e.g., the second aspect) unless specified otherwise, a ratio by weight of the iron (III) nitrate 9-hydrate to the activated carbon is 2:98.

In a fourth aspect of the disclosure in the present application, which may be combined with any other aspect (e.g., the first aspect) unless specified otherwise, the one or more precursors include silver nitrate (AgNO₃).

In a fifth aspect of the disclosure in the present application, which may be combined with any other aspect (e.g., the fourth aspect) unless specified otherwise, a ratio by weight of the silver nitrate to the activated carbon is 1:99.

In a sixth aspect of the disclosure in the present application, which may be combined with any other aspect (e.g., the first aspect) unless specified otherwise, the one or more precursors include silver nitrate (AgNO₃) and iron (III) nitrate 9-hydrate (Fe(NO₃)₃·9H₂O).

In a seventh aspect of the disclosure in the present application, which may be combined with any other aspect (e.g., the sixth aspect) unless specified otherwise, a ratio by weight of the silver nitrate to the iron (III) nitrate 9-hydrate is 1:2.

In an eighth aspect of the disclosure in the present application, which may be combined with any other aspect (e.g., the sixth aspect) unless specified otherwise, a ratio by weight of the silver nitrate to the iron (III) nitrate 9-hydrate to the activated carbon is 1:2:97.

In a ninth aspect of the disclosure in the present application, which may be combined with any other aspect (e.g., the first aspect) unless specified otherwise, the saturated activated carbon is heated at 450° C.

In a tenth aspect of the disclosure in the present application, which may be combined with any other aspect (e.g., the first aspect) unless specified otherwise, the predetermined amount of time is less than two hours.

In an eleventh aspect of the disclosure in the present application, which may be combined with any other aspect (e.g., the first aspect) unless specified otherwise, the predetermined amount of time is one hour.

In a twelfth aspect of the disclosure in the present application, which may be combined with any other aspect (e.g., the first aspect) unless specified otherwise, and environment in which the saturated activated carbon is heated includes air.

In a thirteenth aspect of the disclosure in the present application, which may be combined with any other aspect (e.g., the first or twelfth aspect) unless specified otherwise, the environment is an interior of a muffle furnace.

In a fourteenth aspect of the disclosure in the present application, which may be combined with any other aspect unless specified otherwise, a method of fabricating a filter includes dissolving one or more precursors in a liquid, thereby forming mixture solution. The mixture solution may be sprayed on activated carbon such that the activated carbon is saturated with the mixture solution. The saturated activated carbon may then be heated for a predetermined amount of time, thereby forming the composite water filtration material. The filter may then be assembled with the composite filtration material.

In a fifteenth aspect of the disclosure in the present application, which may be combined with any other aspect (e.g., the fourteenth aspect) unless specified otherwise, assembling the filter includes positioning the composite filtration material within a filter housing and between first and second sediment filter layers.

In a sixteenth aspect of the disclosure in the present application, which may be combined with any other aspect unless specified otherwise, filter includes a filter housing in a composite filtration material contained within the filter housing. The composite filtration material includes active carbon, silver, and iron oxide.

In a seventeenth aspect of the disclosure in the present application, which may be combined with any other aspect (e.g., the sixteenth aspect) unless specified otherwise, the activated carbon is doped with the silver and iron oxide via thermal decomposition.

In an eighteenth aspect of the disclosure in the present application, which may be combined with any other aspect (e.g., the sixteenth aspect) unless specified otherwise, the filter further includes a first sediment filter layer and a second sediment filter layer, wherein the composite water filtration material is between the first and second sediment filter layers.

In a nineteenth aspect of the disclosure in the present application, which may be combined with any other aspect (e.g., the eighteenth aspect) unless specified otherwise, each of the first and second sediment filter layers is a sponge.

In a twentieth aspect of the disclosure in the present application, which may be combined with any other aspect (e.g., the sixteenth aspect) unless specified otherwise, a ratio by weight of the activated carbon to the silver to the iron oxide is 97:1:2.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a perspective view of a filter, according to an aspect of the present disclosure.

FIG. 2 illustrates a flowchart of a method for preparing a composite filtration material, according to an aspect of the present disclosure.

FIG. 3 illustrates SEM images of a composite filtration material composed of activated carbon and silver, according to an aspect of the present disclosure.

FIG. 4 illustrates SEM images of a composite filtration material composed of activated carbon and iron oxide, according to an aspect of the present disclosure.

FIGS. 5 and 6 each illustrate SEM images of a composite filtration material composed of activated carbon, silver, and iron oxide, according to an aspect of the present disclosure.

FIG. 7 illustrates a graph of energy dispersive x-ray spectroscopy (EDS) spectrum data of a composite filtration material composed of activated carbon, silver, and iron oxide, according to an aspect of the present disclosure.

FIG. 8 illustrates EDS mapping of a composite filtration material composed of activated carbon, silver, and iron oxide, according to an aspect of the present disclosure.

FIG. 9 illustrates graphs of XRD data for (a) activated carbon, (b) iron oxide and silver, and (c) activated carbon doped with iron oxide and silver, according to an aspect of the present disclosure.

FIG. 10 illustrates a TEM image of a composite filtration material composed of activated carbon, silver, and iron oxide, according to an aspect of the present disclosure.

FIG. 11 illustrates an EDS mapping image of a composite filtration material composed of activated carbon, silver, and iron oxide, according to an aspect of the present disclosure.

FIG. 12 illustrates a photograph of a prototype water treatment filter, according to an aspect of the present disclosure.

### DETAILED DESCRIPTION

The present application provides a new and innovative composite filtration material and a method for preparing the same. A filter is also provided that is fabricated with the presently disclosed composite filtration material. In some aspects, the provided composite filtration material may include activated carbon doped with silver. In some aspects, the provided composite filtration material may include activated carbon doped with iron oxide. In some aspects, the provided composite filtration material may include activated carbon doped with silver and iron oxide. A one-step thermal decomposition process is provided that may be employed to prepare the provided composite filtration materials. The one-step thermal decomposition process may include dissolving one or more precursors in water, spraying the dissolved one or more precursors onto activated carbon, and heating the activated carbon saturated with the one or more precursors for a predetermined amount of time. As such, the provided composite filtration material can be prepared in a matter of a couple hours (e.g., between one and three hours) and can therefore take less time than at least some typical filtration material preparation methods. The inventors have also found that the provided composite filtration materials are more effective (e.g., higher removal of pollutants) and have a longer service life as compared to typical activated carbon filtration materials.

In one implementation, the provided composite filtration material can be used as a water treatment filter. For example, a filter including the provided composite filtration material can filter contaminated water for the removal of turbidity and particular matter particles, the removal of bacteria, and the removal of organic pollutants and disinfection by-products from water. In some aspects, a filter including the provided composite filtration material may filter water for the removal of heavy metals. The filtration provided by the presently disclosed composite filtration material can additionally help improve water taste and odor.

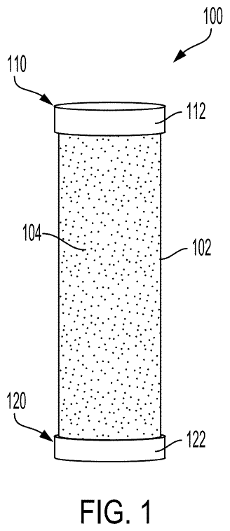

FIG. 1 illustrates a perspective view of an example filter 100. The example filter 100 may include a filter housing 102. In at least some aspects, the filter housing 102 may be constructed of a plastic or another suitable material. A composite filtration material 104 may be contained within the filter housing 102. The composite filtration material 104 includes activated carbon. In some aspects, the activated carbon of the composite filtration material 104 may be doped with silver (e.g., silver nanoparticles). In one example of such aspects, a ratio by weight of the activated carbon to the silver is 99:1.

In other aspects, the activated carbon of the composite filtration material 104 may be doped with iron oxide (e.g., iron oxide nanoparticles). In one example of such other aspects, a ratio by weight of the activated carbon to the iron oxide is 98:2. In other aspect still, the activated carbon of the composite filtration material 104 may be doped with silver and iron oxide. In one example of such other aspects, a ratio by weight of the activated carbon to the silver to the iron oxide is 97:1:2. In at least some examples, the activated carbon of the composite filtration material 104 may be doped with silver and/or iron oxide via a thermal decomposition process described below.

The composite filtration material 104 may be contained within the filter housing 102 by a cap 110 and a cap 120 positioned at opposing ends of the filter housing 102. The cap 110 and the cap 120 may each respectively include a sediment filter layer 112, 122 constructed to filter sediment from a liquid (e.g., water) flowing through the filter 100. In at least one example, each sediment filter layer 112, 122 may be a sponge.

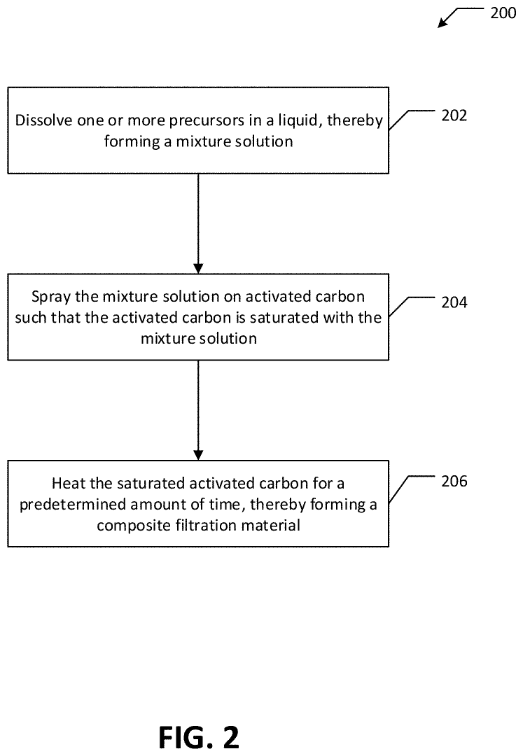

FIG. 2 shows a flowchart of an example method 200 for preparing a composite filtration material (e.g., the composite filtration material 104). Although the example method 200 is described with reference to the flowchart illustrated in FIG. 2, it will be appreciated that many other methods of performing the acts associated with the method 200 may be used. For example, the order of some of the blocks may be changed, certain blocks may be combined with other blocks, and some of the blocks described are optional.

In at least some aspects, one or more precursors may first be dissolved in a liquid (e.g., deionized water) thereby forming a mixture solution (block 202). The one or more precursors may include silver nitrate (AgNO₃) and/or iron (III) nitrate 9-hydrate (Fe(NO₃)₃·9H₂O). For instance, (i) silver nitrate may be used as a precursor to form a composite filtration material 104 including activated carbon doped with silver. In another instance, iron (III) nitrate 9-hydrate may be used as a precursor to form a composite filtration material 104 including activated carbon doped with iron oxide. In another instance, both silver nitrate and iron (III) nitrate 9-hydrate may be used to form a composite filtration material 104 including activated carbon doped with both silver and iron oxide. In some aspects, the one or more precursors may be dissolved in 75 mL of deionized water. In various instances, the one or more precursors may be stirred (e.g., for 5 minutes) while being dissolved in the deionized water. In some instances, the one or more precursors may additionally be subjected to sonication in an ultrasonic bath (e.g., for 5 minutes) while being dissolved in the deionized water.

The mixture solution may then be sprayed on activated carbon such that the activated carbon is saturated with the mixture solution (block 204). In some aspects, a ratio by weight of silver nitrate to activated carbon is 1:99. For example, in such aspects, 1 g of silver nitrate may be dissolved in the deionized water to form the mixture solution (e.g., block 202), which may then be sprayed on 99 g of activated carbon. In some aspects, a ratio by weight of iron (III) nitrate 9-hydrate to activated carbon is 2:98. For example, in such aspects, 2 g of iron (III) nitrate 9-hydrate may be dissolved in the deionized water to form the mixture solution (e.g., block 202), which may then be sprayed on 98 g of activated carbon. In some aspects, a ratio by weight of silver nitrate to iron (III) nitrate 9-hydrate to activated carbon is 1:2:97. For example, in such aspects, 1 g of silver nitrate and 2 g of iron (III) nitrate 9-hydrate may be dissolved in deionized water (e.g., block 202), which may then be sprayed on 97 g of activated carbon.

The activated carbon saturated with the mixture solution may then be heated for a predetermined amount of time (e.g., between one hour and three hours) to thereby form the composite filtration material 104 (block 206). For example, the saturated activated carbon may be heated for one hour. In various aspects, the saturated activated carbon is heated at a temperature of around 450° C. or greater. For example, the saturated activated carbon may be heated at a temperature of 450° C. At temperatures greater than 450° C. the saturated activated carbon may be heated in an environment that includes an inert gas (e.g., argon), which helps prevent the activated carbon from burning. In one example, the saturated activated carbon is heated at 450° C. for one hour. Accordingly, the example method 200 can be completed in less time than at least some typical filtration material preparation methods. Heating the saturated activated carbon for the predetermined amount of time forms the composite filtration material via thermal decomposition, and therefore the method 200 may be referred to herein as a one-step thermal decomposition process.

In some aspects, the environment in which the saturated activated carbon is heated is an interior of a muffle furnace. In some aspects, the saturated activated carbon may be positioned inside an alumina crucible while being heated. The alumina crucible may then be positioned within a muffle furnace or other suitable heating environment. In some aspects, the saturated activated carbon is heated within an environment that includes ambient air. Accordingly, in such aspects, the example method 200 avoids the use of nitrogen or argon flows, which can increase the complexity of typical filtration material preparation methods. As described above, depending on the one or more precursors used, the formed composite filtration material 104 includes activated carbon doped with silver and/or iron oxide.

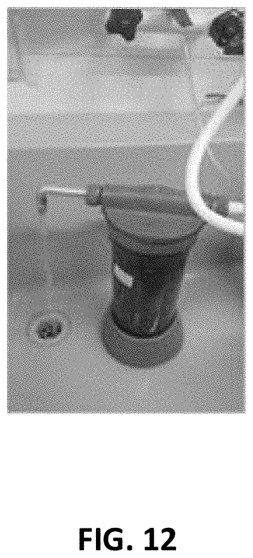

In various aspects, once the formed composite filtration material 104 has cooled, it may be removed from the heating environment (e.g., the muffle furnace). A filter (e.g., the filter 100) may then be fabricated, or assembled, using the composite filtration material 104. For example, assembling the filter 100 may include positioning the composite filtration material 104 within a filter housing (e.g., the filter housing 102) and between first and second sediment filter layers (e.g., the sediment filter layers 112, 122). For instance, the caps 110 and 120 may be placed on either side of the filter housing 102 after positioning the composite filtration material 104 within the filter housing 102. FIG. 12 illustrates a photograph of an example filter.

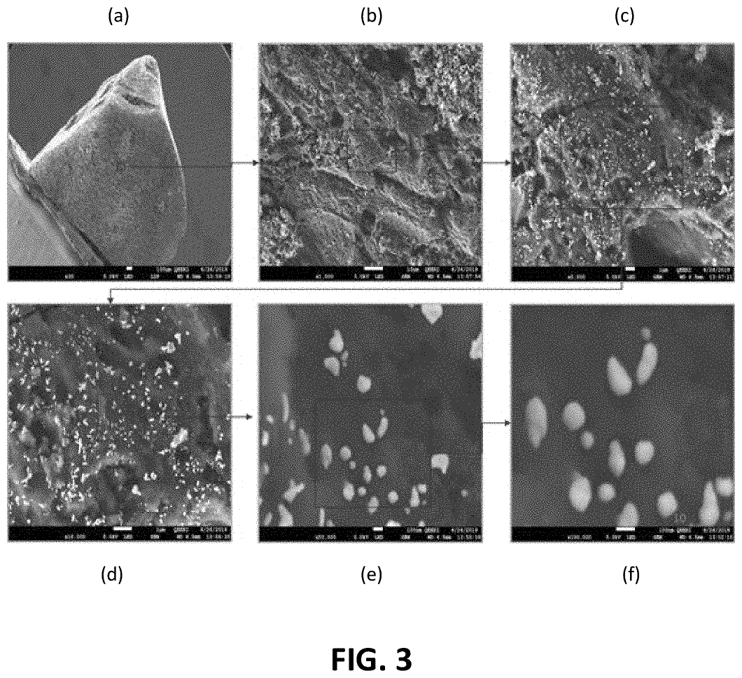

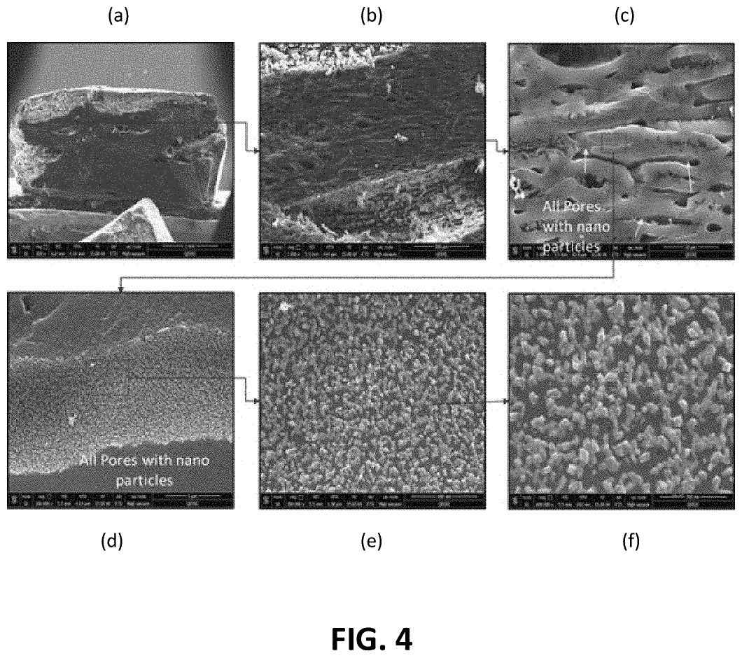

The inventors validated the formation of the above described composite filtration materials via the example method 200 using various imaging and material characterization techniques. FIG. 3 illustrates SEM images with increasing magnification from (a) to (f) of the surface of a composite filtration material including activated carbon doped with silver nanoparticles, which are shown as white particles regularly distributed over the surface and cross section of the composite filtration material (FIG. 3(c)-(f)). FIG. 4 illustrates SEM images with increasing magnification from (a) to (f) of the surface of a composite filtration material including activated carbon doped with iron oxide, where iron oxide nanoparticles are clearly displayed in FIG. 4(d) to (f).

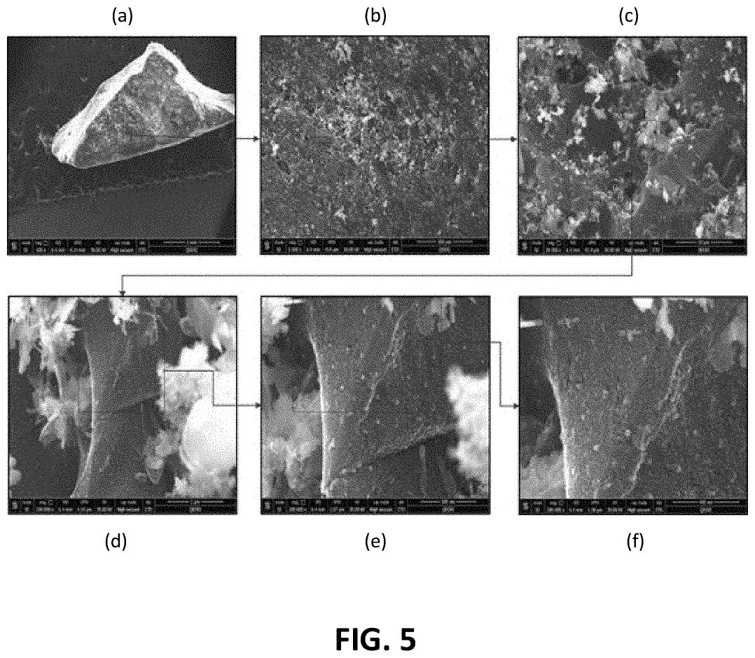

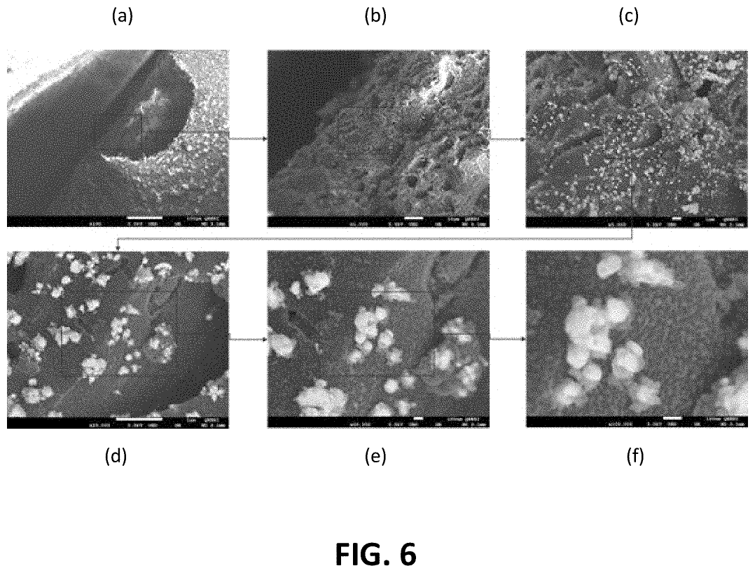

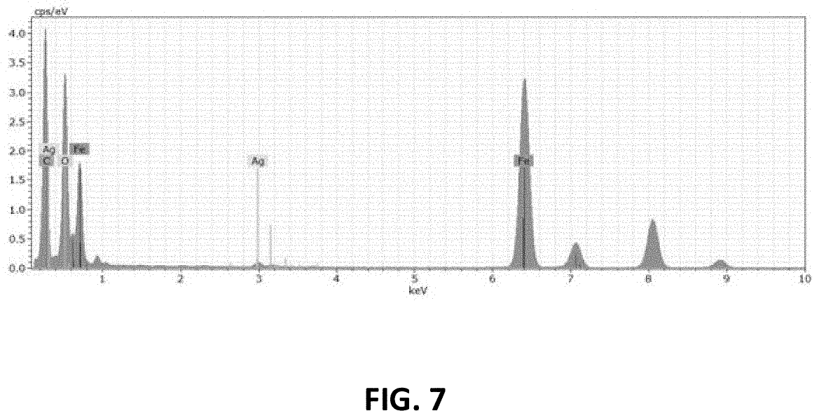

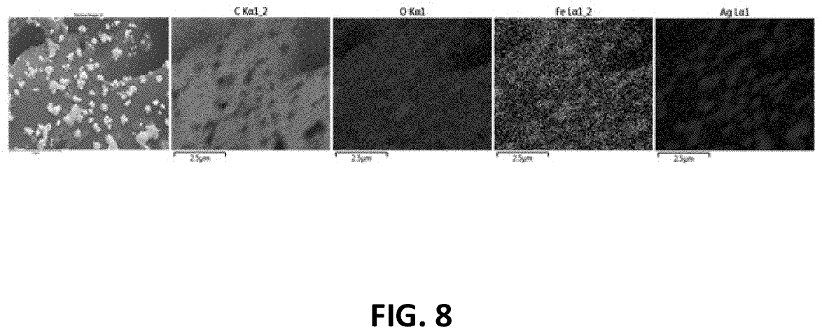

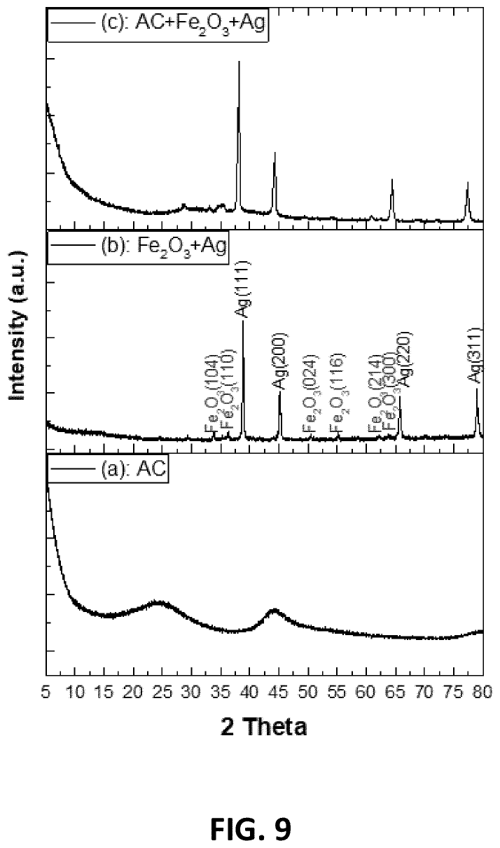

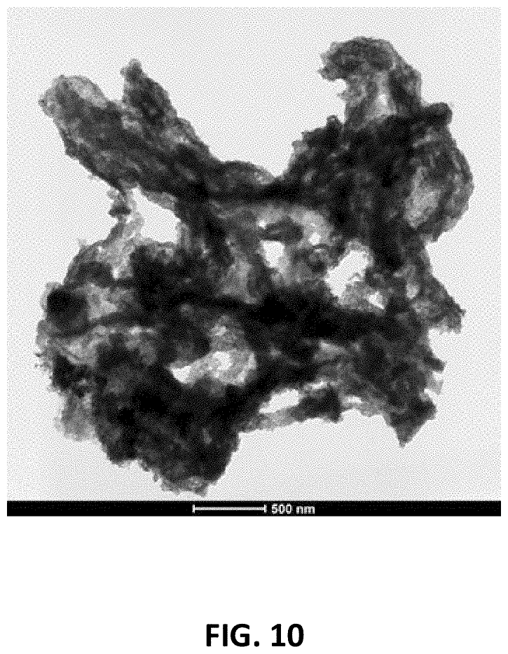

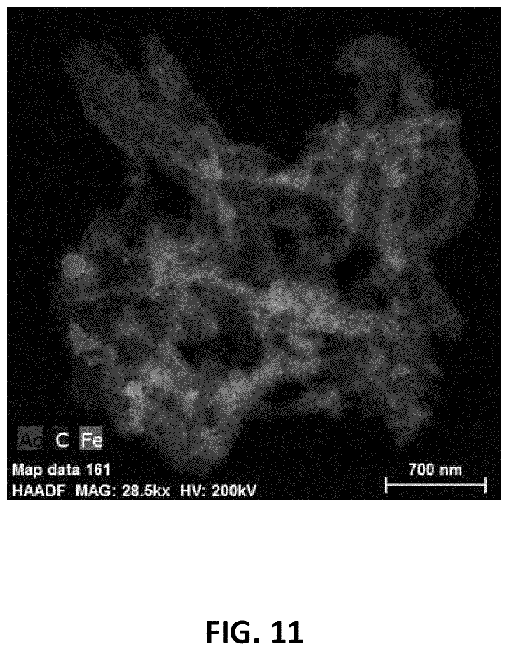

FIGS. 5 and 6 each illustrate SEM images with increasing magnification from (a) to (f) of the surface of a composite filtration material including activated carbon doped with silver and iron oxide. The silver and iron oxide are seen as white particles on the surface of the activated carbon, which was confirmed by x-ray diffraction patterns shown in FIG. 9(b) and (c) and by energy dispersive x-ray spectroscopy (EDS) analysis shown in FIGS. 7 and 8. FIG. 7 illustrates EDS spectrum data of a composite filtration material including activated carbon doped with silver and iron oxide. FIG. 8 illustrates an EDS mapping of a composite filtration material including activated carbon doped with silver and iron oxide. FIG. 9 illustrates x-ray diffraction (XRD) graphs of (a) activated carbon, (b) iron oxide and silver, and (c) a composite filtration material including activated carbon doped with silver and iron oxide. The x-ray diffraction patterns shown in FIG. 9 displays growth of iron oxide and silver nanoparticles on activated carbon. FIG. 10 illustrates a TEM image of a composite filtration material including activated carbon doped with silver and iron oxide. FIG. 11 illustrates an EDS mapping of a composite filtration material including activated carbon doped with silver and iron oxide. The EDS mapping confirms the presence of three main elements (carbon, iron, and silver) in the synthesized composite filtration material.

The inventors also measured the performance of the provided filter 100 having a composite filtration material 104 including activated carbon doped with silver and iron oxide compared to a typical water filter. To measure the performance, the inventors treated tap water for six hours using each the provided filter 100 and a typical water filter, and measured both the total bacterial count and the turbidity of the tap water, the tap water treated with the provided filter 100, and the tap water treated with the typical water filter. To evaluate the bacterial content, water samples were passed through a 0.22 μm cellulose filter disc and each disc was incubated in a Luria broth agar at 37° C. An average of the three readings was calculated as the total bacterial count for each water sample. The results are shown in Table 1 below. The total bacterial count was measured in Colony Forming Units (CFU) per 100 mL. The turbidity was measured in Nephelometric Turbidity Units (NTU).

TABLE 1

| | Total bacterial count | Turbidity |
|---|---|---|
| Water | (CFU/100 ml) | (NTU) |
| Tap Water | 107 ± 5 | 0.67 |
| Typical filter | 224 ± 10 | 0.50 |
| AC + 1% Ag + 2% Fe₂O₃ filter | Not detectable | 0.08 |

As demonstrated by the results shown in Table 1, water treated by the presently disclosed filter 100 having a composite filtration material 104 including activated carbon doped with silver and iron oxide had a lower total bacterial count and turbidity than the water treated by the typical water filter. In fact, the presently disclosed filter 100 completely removed bacteria from the tap water. Additionally, the presently disclosed filter 100 removed six times more turbidity from the tap water as compared to the typical water filter that was used.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole or fractions, within the range inclusive of the ends of the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Without further elaboration, it is believed that one skilled in the art can use the preceding description to utilize the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

1. A method of preparing a composite filtration material comprising:
dissolving one or more precursors in a liquid, thereby forming a mixture solution;
spraying the mixture solution on activated carbon such that the activated carbon is saturated with the mixture solution; and
heating the saturated activated carbon for a predetermined amount of time, thereby forming the composite water filtration material.

2. The method of claim 1, wherein the one or more precursors include iron (III) nitrate 9-hydrate (Fe(NO₃)_{3.9}·9H₂O).

3. The method of claim 2, wherein a ratio by weight of the iron (III) nitrate 9-hydrate to the activated carbon is 2:98.

4. The method of claim 1, wherein the one or more precursors include silver nitrate (AgNO₃).

5. The method of claim 2, wherein a ratio by weight of the silver nitrate to the activated carbon is 1:99.

6. The method of claim 1, wherein the one or more precursors include silver nitrate (AgNO₃) and iron (III) nitrate 9-hydrate (Fe(NO₃)₃·9H₂O).

7. The method of claim 6, wherein a ratio by weight of the silver nitrate to the iron (III) nitrate 9-hydrate is 1:2.

8. The method of claim 6, wherein a ratio by weight of the silver nitrate to the iron (III) nitrate 9-hydrate to the activated carbon is 1:2:97.

9. The method of claim 1, wherein the saturated activated carbon is heated at 450° C.

10. The method of claim 1, wherein the predetermined amount of time is less than two hours.

11. The method of claim 1, wherein the predetermined amount of time is one hour.

12. The method of claim 1, wherein an environment in which the saturated activated carbon is heated includes air.

13. The method of claim 12, wherein the environment is an interior of a muffle furnace.

14. A method of fabricating a filter comprising:
dissolving one or more precursors in a liquid, thereby forming a mixture solution;
spraying the mixture solution on activated carbon such that the activated carbon is saturated with the mixture solution;
heating the saturated activated carbon for a predetermined amount of time, thereby forming a composite filtration material; and
assembling the filter with the composite filtration material.

15. The method of claim 14, wherein assembling the filter includes positioning the composite filtration material within a filter housing and between first and second sediment filter layers.

16. A filter comprising:
a filter housing; and
a composite filtration material contained within the filter housing, wherein the composite filtration material includes activated carbon, silver, and iron oxide.

17. The filter of claim 16, wherein the activated carbon is doped with the silver and the iron oxide via thermal decomposition.

18. The filter of claim 16, further comprising a first sediment filter layer and a second sediment filter layer, wherein the composite water filtration material is between the first and second sediment filter layers.

19. The filter of claim 18, wherein each of the first and second sediment filter layers is a sponge.

20. The filter of claim 16, wherein a ratio by weight of the activated carbon to the silver to the iron oxide is 97:1:2.
